(19) United States
(12) Patent Application Publication
(10) Pub. No.: US 2017/0046152 A1
(43) Pub. Date: Feb. 16, 2017

(54) FIRMWARE UPDATE

(71) Applicant: Quanta Computer Inc., Taoyuan City (TW)

(72) Inventors: Ching-Chih SHIH, Taoyuan City (TW); Yang-Li CHIU, Taoyuan City (TW)

(21) Appl. No.: 14/824,452

(22) Filed: Aug. 12, 2015

(51) Int. Cl. G06F 9/445; G06F 11/07; G06F 9/44

(52) U.S. Cl. CPC G06F 8/665; G06F 9/4401; G06F 11/073; G06F 11/0787

(57) ABSTRACT

A management controller can dynamically manage the firmware update of a storage node in a server system. For example, an administrative device can determine the up-to-date firmware version for a storage device or a memory device associated with storage device controller, such as a SAS expander. The administrative device can send the updated firmware image to a management controller. The firmware image is a bit-by-bit replication of the updated firmware. The management controller can send the updated firmware image to storage device controller. The storage device controller can determine whether the updated firmware image is for the storage device or for the memory device associated with the storage device controller. Upon determining, updating the firmware image in the designated device can be performed. The success log and failure log can be reported to the management controller.

### TECHNICAL FIELD

The disclosure generally relates to managing storage node firmware in a server device.

### BACKGROUND

Storage nodes, such as just bunch of disk (JBOD) nodes, are often composed of multiple storage devices and a controller, such as a serial attached SCSI (SAS) expander or other components. Storage nodes also typically require various firmwares to operate the various components therein, each of which may be updated with new firmware to provide improved functionality for the various components and, thus, for the storage node. The firmware updates can be performed locally at the storage node or via an update server connected to the storage node (i.e., a “one-to-one update”). In the case of a one-to-one update, the update server can include firmware update tools, such as an expander firmware tool or an HDD firmware tool. To update the firmware at the storage node, the storage node is connected to the update server (e.g., via a SAS cable), an authorization process can be performed, and the update can take place.

However, as data storage needs continue to increase, the number of storage devices within a single storage node may continue to increase, possibly to thousands of storage devices. Moreover, the number of storage nodes required may also continue to increase. Consequently, as the number of storage nodes increases and the number of storage devices in each storage node requiring periodic firmware updates also increases, the more difficult it becomes to maintain firmwares in such storage nodes up-to-date through traditional one-to-one update processes.

### SUMMARY

Additional features and advantages of the disclosure can be understood and achieved by means of the instruments and combinations particularly pointed out in the appended claims, or can be learned by the practice of the principles set forth herein.

The present technology is directed to systems and methods for managing firmwares across different devices, such as storage nodes. In operation, a management controller, in communication with an administrative device, can be used to dynamically manage firmware updates for a storage node in a server system. For example, the administrative device can determine the latest firmware version for a storage device, a storage device controller (e.g., a SAS expander), or other component at a storage node. The administrative device can then send the updated firmware image to the management controller for the storage node. The management controller can thereafter send the updated firmware image to the storage device controller associated with the storage or memory device to be updated. Then, the storage device controller can determine whether the updated firmware image is for the storage device or for the storage device controller itself. Upon determining which device the firmware update is associated with, the firmware update for the designated device can be performed. In some configurations, a log file indicating a success or failure of the firmware update process can be provided to the management controller. The management controller can then transmit the file to the administrative device or other component.

Details of one or more implementations are set forth in the accompanying drawings and the following description. Other features, aspects, and potential advantages will be apparent from the description, drawings, and claims.

### DESCRIPTION OF THE DRAWINGS

FIG. 1 is a block diagram of an exemplary system for performing firmware updates at a storage node.

FIG. 2A and FIG. 2B are block diagrams of exemplary systems for performing firmware updates for memory devices associated with a SAS expander.

FIG. 3 is a flowchart illustrating an exemplary process for transmitting a firmware image from a management controller to a SAS expander.

FIG. 4 is a flowchart illustrating an exemplary process for updating firmware at a memory device associated with a SAS expander.

FIG. 5 is a flowchart illustrating an exemplary process for updating firmware at a storage device.

FIG. 6 is a block diagram illustrating an exemplary system of a computing device for implementing the features and processes of FIGS. 1-5.

Like reference symbols in the various drawings indicate like elements.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

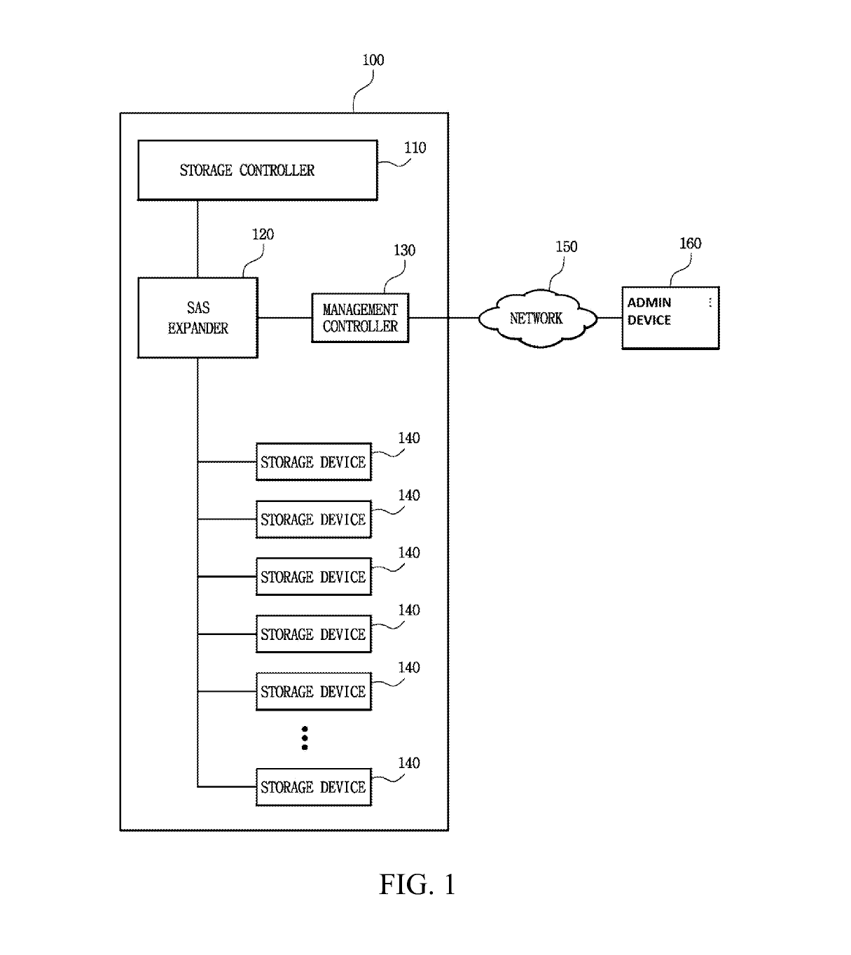

The present technology is directed to systems and methods for managing firmwares across different devices, such as different storage nodes. In operation, a management controller, in communication with an administrative device, can be used to dynamically manage firmware updates for a storage node in a server system. This process is described below with respect to FIG. 1. FIG. 1 is a block diagram of an exemplary system for performing firmware updates at a storage node 100 according to the present technology. As illustrated in FIG. 1, a storage node 100 can include a storage controller 110, a SAS expander 120, a management controller 130, and one or more storage devices 140. The storage node 100 can be communicatively coupled to an administrative device 160 (e.g., laptop computer, tablet computer, smartphone, etc.) over a network 150 (e.g., local area network, wide area network, the Internet, etc.), where the storage node 100 is communicatively coupled to the network 150 via a management controller 130.

The storage node 100 can be a managed server device that includes a management controller 130 for out-of-band management of a storage node 100. For example, the management controller can be a baseboard management controller (BMC) for use with an Intelligent Platform Management Interface (IPMI) or a Redfish application program interface (API). The baseboard management controller can operate independently of a central processing unit (e.g., storage controller 110) of the storage node 100 and/or the operating system of the storage node 100. The management controller 130 can be configured with an operating system and/or other computer-readable instructions for performing operations at the storage devices 140 from a remote location (e.g., at administrative device 160), as described herein. In operation, the management controller 130 can obtain server configuration information for the storage node 100 from the administrative device 160 through network 150. The management controller 130 can then communicate with storage device 140 via the SAS expander 120 or other components. The management controller 130 can be configured to communicate with the SAS expander 120 in a variety of ways. For example, an Inter-Integrated circuit/system management bus interface (I2C/SMbus) can be provided.

The SAS expander 120 can be configured to communicate with the management controller 130 to support remote management of the storage device 140, including updating of firmwares at the storage devices 140. In operation, the SAS expander 120 is configured to receive an updated firmware image from the management controller 130 and determine that the updated firmware is for the storage devices 140. The SAS expander 120 then stores the firmware image and updates the firmware. For example, the SAS expander 120 can store firmware images in one or more of storage devices 140 for later use by the SAS expander 120 for updating of the firmwares of the storage devices 140.

Although the SAS expander 120 and the management controller 130 are described herein a being separate components, the various embodiments are not limited in this regard. Rather, the present disclosure contemplates that in some embodiments, a SAS expander with network capabilities can also be configured to also operate as the management controller for a storage node.

Further, although the various embodiments are described in terms of a SAS expander, the present disclosure contemplates that the methods described herein can be utilized with any other types of storage device controllers or components including such controllers. For example, the methods described herein can also leveraged for updating firmwares for computing devices utilizing a PCIe bridge and switch to connect NMVe solid state drives to a compute node. However, the various embodiments are not limited to SAS expander and PCIe bridge and switch technologies and can be utilized with any other technologies.

As shown in FIG. 1, the storage node 100 can include several individual storage devices 140. For example, each of storage devices 140 can be a hard-disk drive (HDD) for storing data files or computer program instructions. However, in some embodiments, storage devices 140 can be configured in a redundant array of inexpensive disk (RAID) configuration, which divides the data and is associated with parallel transmission and reading of the data. In other embodiments, a JBOD configuration can be utilized to avoid the need for RAID functionality. However, the present disclosure contemplates that the methods described herein can be utilized with any configuration of storage devices.

As further shown in FIG. 1, the storage node 100 can also include a storage controller 110 in communication with the SAS expander 120. For example, the storage controller 110 can be a serial ATA (SATA) host bus adapter (HBA). The storage controller 110 can also have an Ethernet connection through a serial port (not shown) to communicate with other devices.

As noted above, an administrative device 160, such as a server management system (SMS), can be used to monitor and remotely control operations at the storage node 100. Further, the administrative device 160 can be used to determine when there is updated firmware available for any of the storage devices 140 in the storage node 100. For example, the administrative device 160 can send a query to the management controller 130 to request information regarding a current version of the firmwares for the storage devices 140 or any other components of storage node 100. The management device 130, in turn, queries the components of the storage node 100 for firmware version information, such as the firmware version currently running in the storage devices 140. The management device 130 can then collect the firmware information and send it back to the administrative device 160 through the network 150.

Upon receiving the information regarding the current firmware version of the storage devices 140 (or any other components at the storage node 100), the administrative device 160 can then determine whether any of the firmware at the storage node 100, such as the firmware for any of the storage devices 140, needs to be updated. If an update is needed for any component, the administrative device 160 retrieves the necessary firmware and provides it, via network 150, to the management controller 130. The management controller 130 can then provide the firmware to the SAS expander 120 for installation at the corresponding one of storage devices 140 or other component of storage node 100.

The present disclosure contemplates that in some instances, it may not be possible to obtain the firmware version of a one of the storage device 140 or other components. For example, one of storage nodes 140 may have corrupted firmware, the SAS expander 120 may be defective and unable to properly read the firmware version at the storage nodes 140, or a problem may exist at the management controller 130 or the administrative device 160 that prevents a proper reading of the firmware information for a particular component. Alternatively, the firmware version information may be invalid or improper for the type of component. To account for cases where the administrative device 160 is not able to determine the firmware version for one or more of the storage devices 140 or some other issue with the firmware arises, a policy can be implemented at the administrative device 160 to cause the firmware to be updated automatically. For example, if a current firmware version of any one of the storage devices 140 cannot be identified, a policy at the administrative device 160 can dictate that the firmware for the one of the storage devices 140 is automatically updated to the latest version available. However, in some embodiments, the policy can dictate that the firmware be updated to a particular version, which may or may not be the latest version. Such a configuration can be provided to ensure that the one of the storage devices 140 or other component of storage node 100 is updated to a trusted version. Similarly, policies can be specified for other components of the storage node 100.

In the various embodiments, the firmware is provided in various forms. For example, in some embodiments, the firmware image can be a bit-by-bit replication of the updated firmware that can be directly written to the component to be updated. In other embodiments, the firmware image may be stored according to a data compression algorithm, requiring some pre-processing of the firmware via one or more components of the storage node 100 and/or the administrative device 160.

In operation, the administrative device 160 can send the updated firmware image to the management controller 130 through the network 150. In some embodiments, the management controller 130 can manage the updating of the firmware at the storage node 100 by applying the firmware updates directly. Alternatively, the management controller 130 can direct the SAS expander 120 or the storage controller 110 to perform the updating.

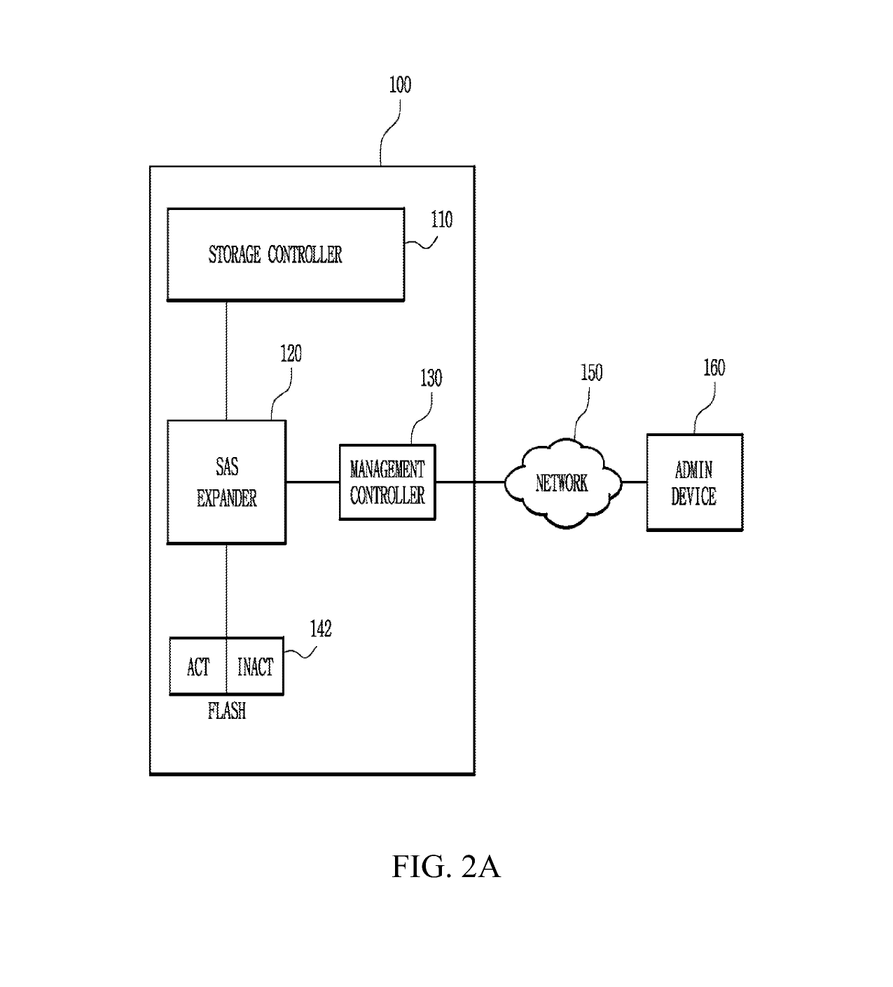

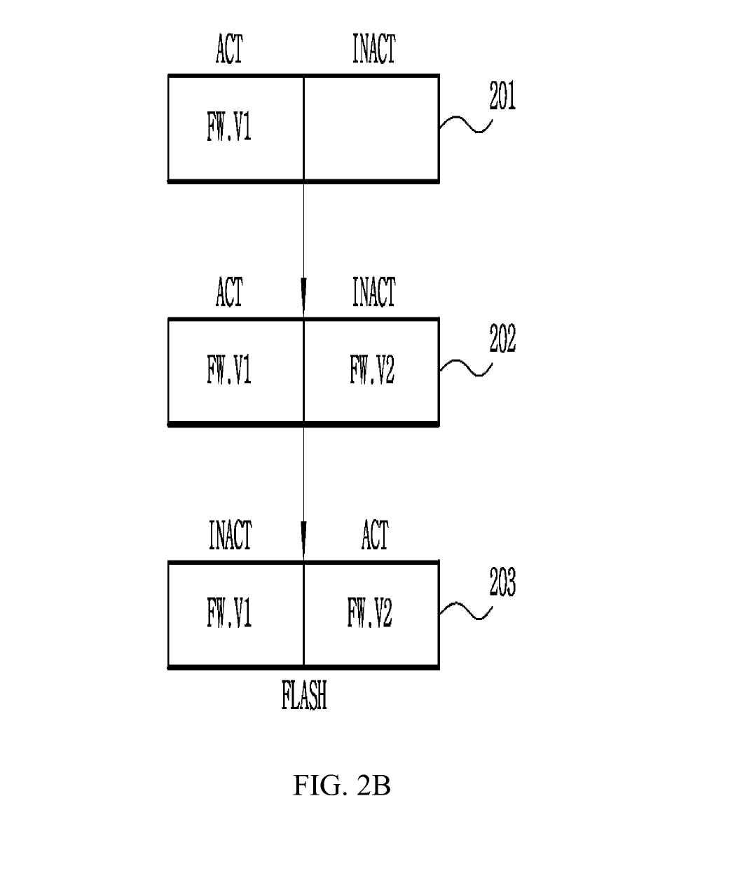

FIG. 2A and FIG. 2B are simplified versions of FIG. 1 for illustrating the firmware update process for a memory device 142 associated with a SAS expander 120 in storage node 100. In operation, the administrative device 160 sends a query to a management controller 130 requesting an identification of a current version of the firmware associated with the SAS expander 120. For example, the version stored in the active region (ACT) of memory device 142 can be reported to the management controller 130. The management device 130 receives the results of the query and collects information related to the firmware version currently running in the memory device 142. This can involve the management controller 130 directly accessing the memory device 142 via the SAS expander 120 or instructing the SAS expander to collect such information and return it to the management controller 130. The firmware information for memory device 142 can then be sent by the management controller 130, via network 150, to the administrative device 160.

Upon receiving the information regarding the current firmware version for the memory device 142, the administrative device 160 determines whether or not the SAS expander 120 has the latest firmware. For example, the administrative device 160 can access a remote database (e.g., a website for a supplier of the memory device or a central firmware database for a datacenter) to obtain information regarding the latest firmware version and compare such information to the firmware information f or the memory device to determine whether an update is needed. If an update is needed, the administrative device can retrieve the latest version of the firmware for the SAS expander 120.

The present disclosure contemplates, that the process for determining whether or not to update a firmware for a particular component may be complex and require consideration of a number of variables. For example, it may be undesirable to update a firmware to a latest version for various reasons. In some cases, it is possible that the latest version of the firmware may include an incompatibility with other components of the storage node 100. In other cases, it may not be desirable to update a firmware until it has been thoroughly tested. Thus, in some embodiments, the determination of whether or not to update a firmware may include checking with one or more additional databases to verify whether a particular firmware is approved for deployment. As a result, there may be instances where updated firmware is available, but will not be installed.

In the event that an update is needed, the administrative device 160 can retrieve and provide a firmware image for the updating process. The firmware image is an image file containing the contents and structure of the firmware. As noted above, the firmware image can be a sector-by-sector copy of the firmware, thereby perfectly replicating the structure in which the firmware is to be stored at the memory device 142. However, as noted above, the firmware image can be provided in a compressed format or other format, requiring some pre-processing of the firmware image prior to installation.

Regardless of the format of the firmware image, the administrative device 160 can send the updated firmware image to the management controller 130 through the network 150. The firmware image can be sent to the management controller 130 in a format that allows the entire firmware to be transmitted without any corruption or error. Further, the firmware image can be provided in one or more parts. The management controller 130 then receives the updated firmware image from the administrative device 160, and forwards the image to the SAS expander 120. The SAS expander 120 can then store the image in the memory device 142 associated with the SAS expander 120 for the update process.

A firmware updating process can be provided for a SAS expander in a variety of ways. One example of such a method is provided in FIGS. 2A and 2B. As shown in FIG. 2A, the SAS expander can include memory device 142 for storing firmwares for the SAS controller. For example, the SAS expander can include a FLASH memory or other persistent storage device for storing firmwares, As shown in FIG. 2A, the memory device 142 can include at least an active region and an inactive region. The inactive region (i.e., the region into which the updated firmware is to be installed) can be empty or already have a firmware installed therein. The updated firmware can then be installed in this inactive region and activated so that SAS expander looks to the inactive region (now the active region) for firmware to operate. This exemplary process is described below in further detail with respect to FIGS. 2A and 2B.

In the exemplary process of FIGS. 2A and 2B, a memory device is configured with an active region (ACT) that stores the firmware currently in use (FW.V1) and the inactive region (INACT) that is empty (see 201 in FIG. 2B) or that contains some older firmware version. The management controller 130 then provides the update firmware image to the SAS expander 120 and the SAS expander 120 determines if the updated firmware image is for the SAS expander 120 or the storage devices 140 of the storage node. If the SAS expander determines that the updated firmware is for the SAS expander, the SAS expander is configured to store the updated firmware (e.g., FW.V2) in the inactive region of the memory device 142 (see 202 in FIG. 2B). Thus, the inactive region now includes the newly obtained firmware (FW.V2) received from the management controller 130. Thereafter, the inactive region and the active region can be swapped (see 203 in FIG. 2B) so that the inactive region with the latest firmware (FW.V2) become the active region and the active region with the older firmware (FW.V1) becomes the inactive region. The SAS device 120 can then operate using the latest firmware (FW.V2) by accessing the currently active region.

The setting of active and inactive regions can be provided in a variety of ways. In some embodiments, the active and inactive regions of the memory device 142 can be set via a set of active flags or values. For example, the active region can be associated with an active value of “1” and an inactive region can associated with an active value of “0”. To set the memory device 142 to switch firmwares (after writing thereof to the memory device 142), the active flags or values can be changed by switching the active flags or values for the regions using the SAS expander 120. For example, the SAS expander 120 can set the active value of the inactive region as “1” and set the active value of the active region as “0” to swap these two regions and make the updated firmware image (FW.V2) effective, as illustrated in 202 and 203 of FIG. 2B. Once the active flags or values associated with the active region and the inactive regions are swapped, the SAS expander can be rebooted and the inactive region becomes the active region, and the active region becomes the inactive region.

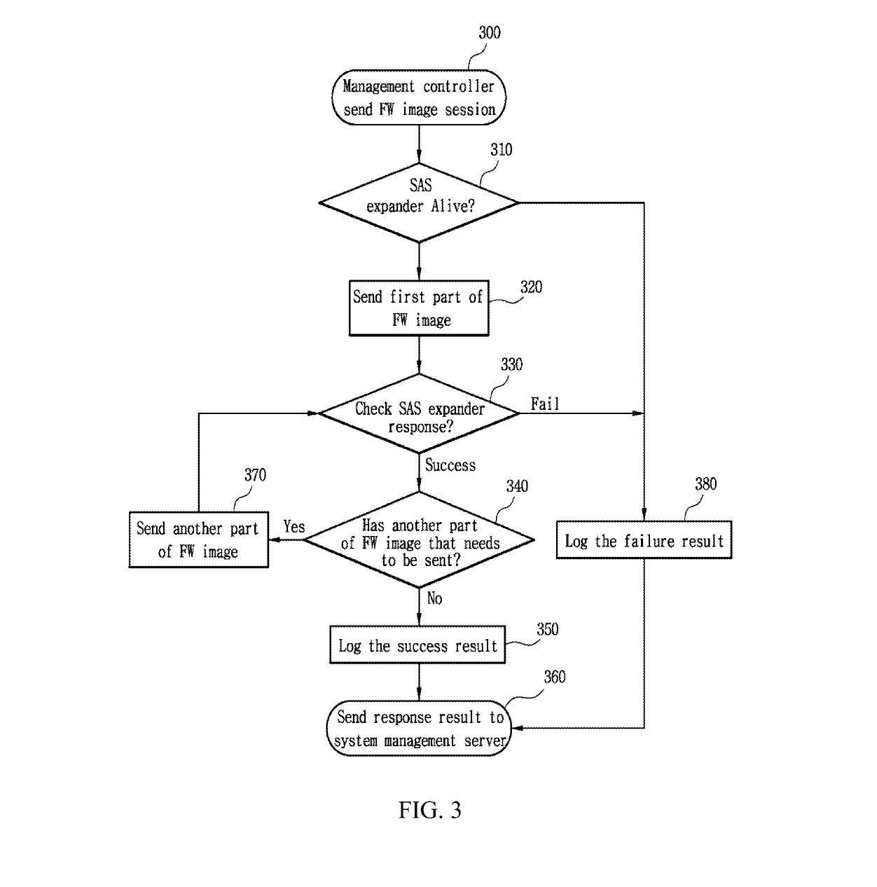

FIG. 3 is a block diagram illustrating an exemplary process of transmitting a firmware image to a SAS expander. This process can be utilized to provide firmware images for either the storage device, the SAS expander, or any other component in a storage node. At step 300, a session to send a firmware image to the SAS expander is initiated. At step 310, the management controller determines whether the SAS expander is “alive”. That is, determining whether the SAS expander is functioning normally and is ready to receive an updated firmware image. If the SAS expander is not functioning or is otherwise inactive, a failure is logged at step 380 and a response is forwarded by the management controller to a system management server (e.g., an administrative device) at step 360. In particular, the response can indicate that the SAS expander is not operating normally and/or cannot able to support remote management of a storage node via the management controller.

Upon determining that the SAS expander is functioning normally and is ready to receive the firmware image at step 310, the management controller can begin to send the firmware image to the SAS expander. For example, the management controller can send at least a first part of the firmware image to the SAS expander at step 320. For example, the first part of the firmware image can be a firmware image for the SAS expander or particular ones of the storage devices in the storage node. Alternatively, the firmware image can be divided into parts at the management controller, the system management server, or elsewhere to facilitate transmission to the SAS expander.

In response to sending the first part of the firmware image at step 320, the management controller can determine, at step 330, a response of the SAS expander to the receipt of the first part of the firmware image. For example, the SAS expander can determine whether the first part of the firmware image was received in its entirety and free of errors. If the response of the SAS expander at step 330 is that the firmware image sent to the SAS expander was corrupted or was otherwise not properly received at the SAS expander, then the management controller can log the resulting failure at step 380. In some embodiments, failures can be logged in a memory of the management controller. In other embodiments, the failures can be logged in the SAS expander or other components. This result can be sent to the system management server (e.g., an administrative device) at step 360.

However, upon determining at step 330 that the firmware image has been properly sent to the SAS expander without any corruption or distortion, the management controller determines if there is are remaining firmware image parts that need to be sent to the SAS expander at step 340. If another part needs to be sent to the SAS expander at step 340, then the management controller can send a next or remaining part of the firmware image to the SAS expander at step 370. The management controller can then repeat steps 330, 340, and 370 until all parts of the firmware image are successfully sent to the SAS expander or until an error occurs. In the case of the latter, the error can be logged at step 380 and a response is sent to the system management server at step 360, as discussed above.

Once it is determined at step 340 that all parts of the firmware image have been provided to the SAS expander, the management controller can log the successful result at step 350. This successful result can then be sent to the system management server at step 360. The management controller can then resume previous processing, including repeating of the method of FIG. 3. Further, the SAS expander can begin updating of the firmware at the SAS expander or the storage devices in the storage node.

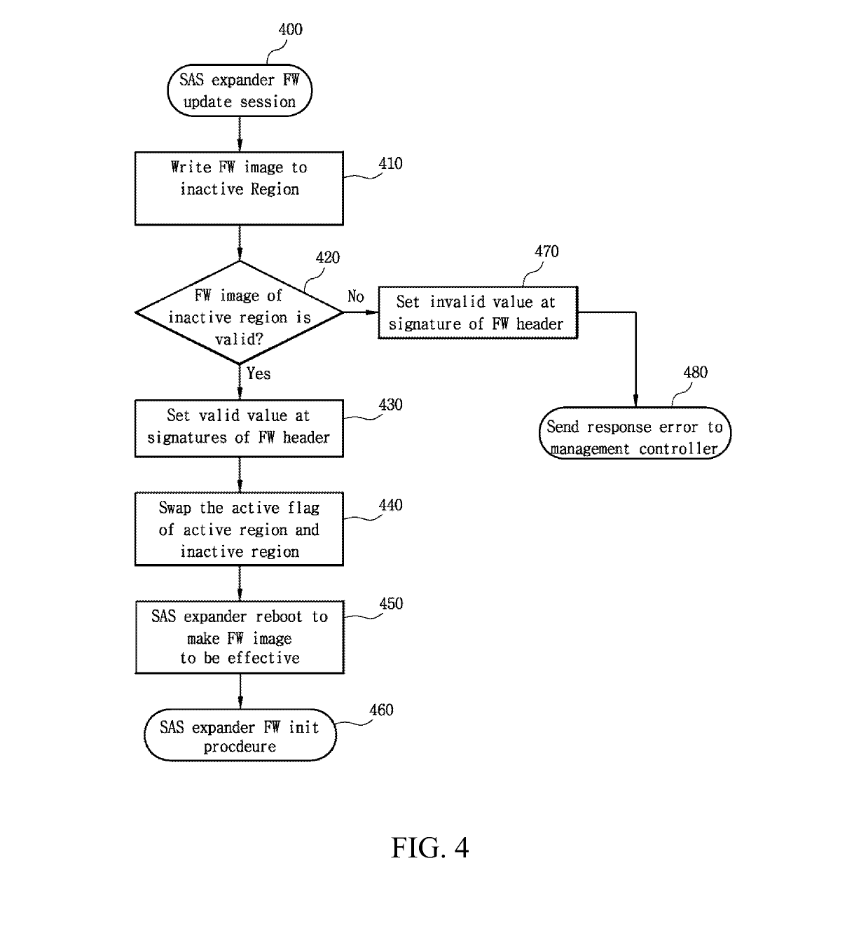

Now turning to FIG. 4, there is shown a block diagram illustrating an exemplary process for updating firmware of a SAS expander via a management controller. The process of FIG. 4 begins at step 400 with initializing a session for performing a firmware update for the SAS expander. This can involve configuring the management controller to prepare the SAS expander for firmware updates by placing the SAS expander in an update mode. In some embodiments, this can require the SAS expander to be placed offline and otherwise removing the SAS expander from service in the storage node. However, the various embodiments are not limited in this regard and steps and processes described herein can be utilized with firmware update processes that allow the SAS expander to be maintained online. Once the session is initiated at step 400, the process can proceed to step 410.

At step 410, an updated firmware image for the SAS expander can be written to the SAS expander. For example, as described above with respect to FIGS. 2A and 2B for a memory device, the SAS expander can also include an active region and an inactive region for storing firmwares. The active region, as described above, can contain the currently running firmware version (e.g., FW.V1 in FIG. 2B). The inactive region may be empty as illustrated in FIG. 2B at 201 or may have a previously installed firmware version. Further, as also described above with respect to FIG. 2B, the active region can associated with a first active value that indicates the active region as holding the firmware to be used by the SAS expander (e.g., “1”) and the inactive region can be associated with a second active value that indicates the inactive region as not holding the firmware to be used by SAS expander (e.g., “0”). At step 410, the firmware image from the management controller (FW.V2) can be written into the inactive region. The writing of the firmware into the inactive region can be performed directly by the management controller in some embodiments. In other embodiments, the management controller can provide the SAS expander the firmware image and the SAS expander can be configured to process and write firmware into the inactive region. However, the writing of the firmware can also be done via any other component.

After writing the firmware image into the inactive region at step 410, the SAS expander determines at step 420 whether the firmware image written into the inactive region is valid. For example, the SAS expander can analyze the firmware in the inactive region to determine whether the firmware image has been written properly in its entirety and without any errors.

If the SAS expander determines at step 420 that the firmware has been properly written into the inactive region, a valid flag or value is set in the inactive firmware region indicating that the firmware written into the inactive region is valid and ready for use. For example, as indicated at step 430, a valid value can be set in the signature of the firmware header. Alternatively, the SAS expander can cause the valid value or flag to be set in a table or database elsewhere. In some embodiments, prior to setting or otherwise changing a valid or flag, the integrity of the image can be analyzed to ensure the image is valid and ready for use. For example, the integrity can be verified by a cyclic redundancy check (CRC) or a checksum. Additionally, the valid value or flag can be reported to the management controller or beyond to monitor the firmware update process.

Once the valid value or flag is set at step 430, the active firmware can be set starting at step 440. First, the active flags or values can be swapped between the inactive and active regions at step 440. In some embodiments, the process at step 440 can include determining, prior to the swapping, that the firmware to be made active includes a valid value or flag to ensure that the SAS expander is set to operate with a valid firmware. This can be used by a boot code to determine where to boot the image. Regardless of whether or not the valid value or flag is checked at step 440, step 440 also includes setting the active flag or value associated with the inactive region with the recently written firmware to indicate as holding the firmware for use by the SAS expander and setting the active flag or value associated with the active region with the to indicate it as not holding the firmware for use by the memory device. For example, the SAS expander can be configured to set the active value of the inactive region to “1” and set the active value of the active region to “0” to swap these two regions. As a result, the firmware in the inactive region becomes the active firmware and the firmware in the active region becomes the inactive firmware, as described above with respect to FIG. 2B.

Once the flag values associated with the active region and the inactive region are swapped at step 440, then the SAS expander can be rebooted at step 450. By rebooting the SAS expander, the inactive region becomes the active region, and the active region becomes the inactive region. The new active region contains the newly written firmware (e.g., FW.V2) and the new inactive region contains the previously running, old firmware (FW.V1). At step 460, a SAS expander initialization procedure begins to have the SAS expander to operate using the newly written firmware.

As noted above with respect to step 420, it is possible that the firmware written to the inactive region is invalid. That is, the firmware in the inactive region may be incomplete or have some errors. In response to detecting that such firmware is invalid at step 420, the valid flag or value in the inactive region is set to indicate an invalid firmware at step 470. For example, the firmware written to inactive region can associated with the valid value of “0”, thus indicating that the invalid firmware should not be used. Thereafter, at step 480, a response error is reported to the management controller or components beyond. Previous processing can then resume, including repeating the method of FIG. 4 or any of the other processes described herein.

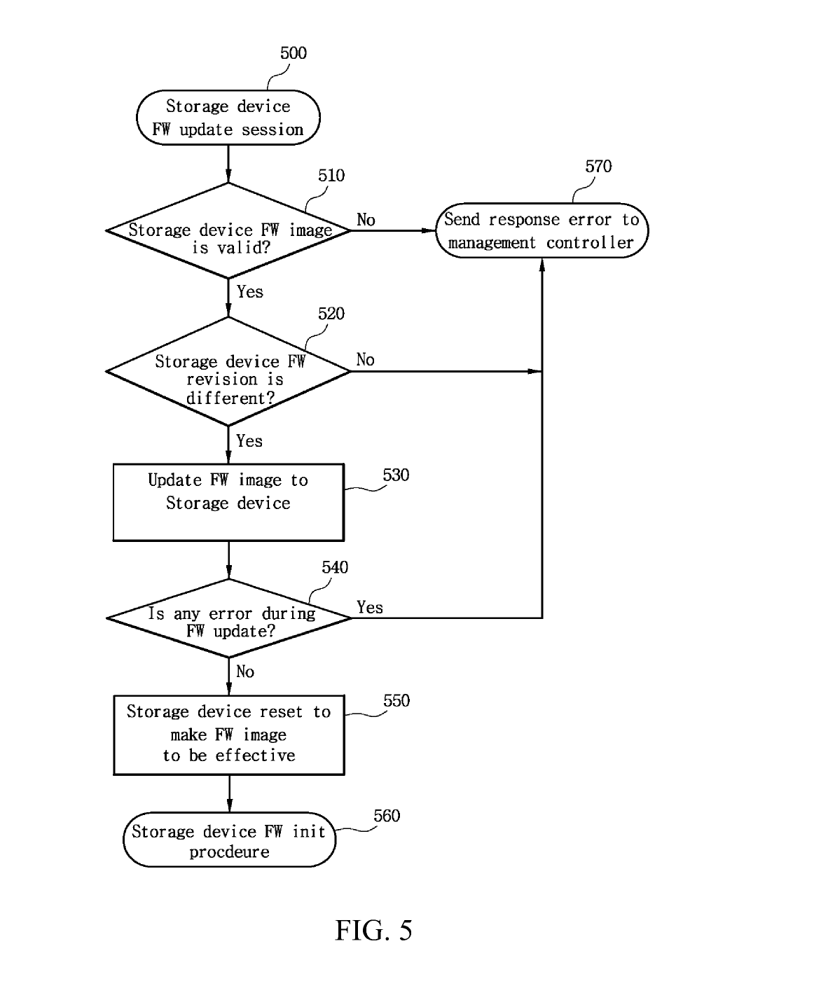

Now turning to FIG. 5, there is shown a block diagram illustrating an exemplary process of updating firmware in a storage device associated with a SAS expander via a management controller. For example, the exemplary process of FIG. 5 can be used to update the storage devices of the storage node of FIG. 1.

The storage device update session beings at step 500. At step 500, a storage device update session can be initiated by the management controller. This step can include, as described above with respect to FIG. 1, the system management server sending a query to the management controller requesting the firmware version that is currently running in the storage devices of the storage node. The management device receives the results of the query and collects information related to the firmware version that is currently running in the storage devices. Thereafter, the management controller can obtain the needed firmware(s) for the storage devices and forward the firmware(s) to the SAS expander. As described above, such firmwares can be available from the system management server or other device over the network.

Once the session is initiated at step 500, the SAS expander determines if the updated storage device firmware image is valid at step 510. Similar to the process in FIG. 4, this can involve the setting of a valid flag or value indicating the firmware image is valid. If the firmware image is not valid at step 510, the process proceeds to step 570. At step 570 an error message can be provided to the management controller regarding the invalid firmware image for logging and/or further processing. If the firmware image is valid at step 510, the process of FIG. 5 can proceed to step 520.

At step 520, the SAS expander can further determine if the firmware is different from the firmware already stored in the storage device at step 520. If the firmware image is not different at step 520, the process again proceeds to step 570. At step 570 an error message can be provided to the management controller indicating the firmware image is already installed for logging and/or further processing. If the firmware image is different at step 520, the process of FIG. 5 can proceed to step 530. At step 530 the firmware update process is performed for the storage devices.

Once the firmware at the storage devices is updated at step 530, the SAS expander determines at step 540 whether any errors occurred during the firmware update. For example, a distortion or corruption of the firmware may be detected before or after the firmware was updated in one or more of the storage devices. In another example, the resulting firmware at the storage device may not be a bit-by-bit reproduction of the firmware provided in the firmware image. Various other errors can be detected during the update process, including but not limited to: image type errors, size errors, integrity (Checksum or CRC) errors, get image timeout errors, and/or update image timeout errors.

If an error is detected at step 540, the process again proceeds to step 570. At step 570 an error message can be provided to the management controller regarding the errors encountered for logging and/or further processing. If no errors have occurred during the update process, then the process can proceed to step 550.

At step 550, then the storage device can be reset to make the firmware image effective. In some embodiments, where the storage devices use a memory device to store firmwares as described above in FIGS. 2A and 2B for the SAS expander. For example, step 550 can also include configuring the active flag or value associated with the storage device to be set by the SAS expander to indicate the desired firmware. Further, step 550 can include having the SAS expander cause the updated storage device to be reboot or reset to have the storage device recognize the newly written firmware. Thereafter, at step 560, the storage device initialization procedure begins to have the storage device to operate using the newly written firmware.

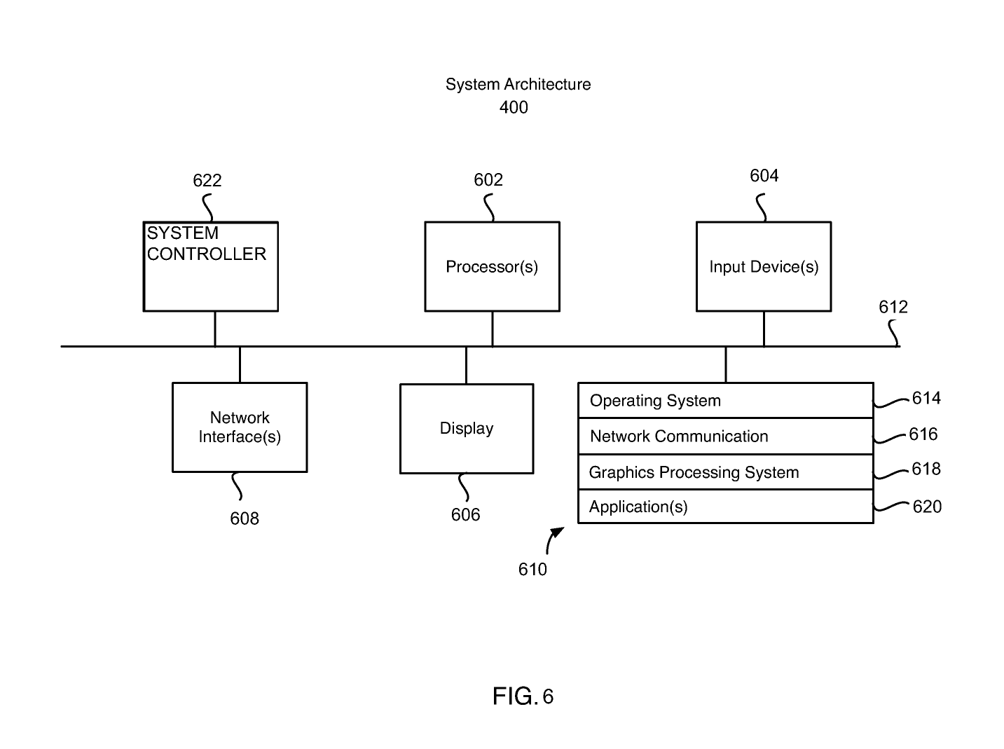

FIG. 6 is a block diagram of an exemplary system architecture 600 that implements the features and processes of FIGS. 1-5. The architecture 600 can be implemented on any electronic device that runs software applications derived from compiled instructions, including but not limited to: personal computers, servers, smart phones, media players, electronic tablets, game consoles, email devices, etc. In some implementations, the architecture 600 includes: one or more processors 602; one or more input devices 604; one or more display devices 606; one or more network interfaces 608; and, one or more computer-readable mediums 610. Each of these components can be coupled by bus 612.

Display device 606 can be any known display technology, including but not limited to display devices using Liquid Crystal Display (LCD) or Light Emitting Diode (LED) technology. Processor(s) 602 can use any known processor technology, including but not limited to graphic processors and multi-core processors. Input device 604 can be any known input device technology, including but not limited to: a keyboard (including a virtual keyboard), mouse, track ball, and touch-sensitive pad or display. Bus 612 can be any known internal or external bus technology, including but not limited to ISA, EISA, PCI, PCI Express, NuBus, USB, Serial ATA or FireWire.

Computer readable medium 610 can be any medium that participates in providing instructions to processor(s) 602 for execution, including but not limited to non-volatile storage media (e.g., optical disks, magnetic disks, flash drives, etc.) or volatile media (e.g., SDRAM, ROM, etc.). The computer readable medium (e.g., storage devices, mediums, and memories) can include, for example, a cable or wireless signal containing a bit stream and the like. However, when mentioned, non-transitory computer-readable storage media expressly excludes media such as energy, carrier signals, electromagnetic waves, and signals per se.

Computer-readable medium 610 can include various instructions 614 for implementing an operating system (e.g., Mac OS®, Windows®, Linux). The operating system can be multi-user, multiprocessing, multitasking, multithreading, real-time and the like. The operating system performs basic tasks, including but not limited to recognizing input from input device 604; sending output to display device 606; keeping track of files and directories on computer-readable medium 610; controlling peripheral devices (e.g., disk drives, printers, etc.) which can be controlled directly or through an I/O controller; and, managing traffic on bus 612. Network communications instructions 616 can establish and maintain network connections (e.g., software for implementing communication protocols, such as TCP/IP, HTTP, Ethernet, etc.).

A graphics processing system 618 includes instructions that provide graphics and image processing capabilities. Application(s) 620 can be an application that uses or implements the processes described in reference to FIGS. 1-5. The processes can also be implemented in operating system 614.

System controller 622 includes at least a storage controller, a management controller, or an SAS expander. The management controller can be a controller that operates independently of processor(s) and/or operating system 614. In some implementations, the management controller can be powered and operational before processor(s) 602 are powered on and operating system 614 is loaded into processor(s) 602. For example, a management controller can provide for pre-OS management of the computing device through a dedicated network interface or other input device. A management controller can be a baseboard management controller (BMC) that monitors storage node firmware and performs low level management of the storage nodes, and/or provides remote management capabilities through an intelligent platform management interface (IPMI), keyboard, video, and mouse (KVM) redirection, serial over LAN (SOL), and/or other interfaces. A management controller can be implemented in the processes described with reference to FIGS. 1-5 above.

SAS expander (serial attached small computer system interfaces) is a controller that controls the firmware of the storage node, and provides remote management capabilities through the Inter-Integrated circuit/system management bus (I2C/SMbus) or SGPIO controller interface. The SAS expander is configured to communicate with the management controllers to support remote management capability. A serial ATA (SATA) host bus adapter (HBA) can be replaced with the SAS expander in this instance.

The described features can be implemented in one or more computer programs that are executable on a programmable system. Such a programmable system can include at least one programmable processor coupled to receive data and instructions from, and to transmit data and instructions to, a data storage system, at least one input device, and at least one output device. A computer program is a set of instructions that can be used directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, for example, both general and special purpose microprocessors, and the sole processor or one of multiple processors or cores, of any kind of computer. Generally, a processor will receive instructions and data from a read-only memory, a random access memory or both. The essential elements of a computer are a processor for executing instructions and one or more memories for storing instructions and data. Generally, a computer will also include: one or more mass storage devices for storing data files. Such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (Cathode Ray Tube) or LCD (Liquid Crystal Display) monitor for displaying information to the user and a keyboard and a pointing device such as a mouse or a trackball by which the user can provide input to the computer.

The features can be implemented in a computer system that includes a back-end component, such as a data server, or that include a middleware component, such as an application server or an Internet server, or that include a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system includes clients and servers. A client and a server are generally remote from each other and typically interact through a network. The relationship of client and server arises by virtue of computer programs running on the respective computers and having a client-server relationship to each other.

One or more features or steps of the disclosed embodiments can be implemented using an API. An API can define one or more parameters that are passed between a calling application and other software code (e.g., an operating system, library routine, function) that provides a service or data, or performs an operation or computation.

The API can be implemented as one or more calls in program code that sends or receives one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer will employ to access functions supporting the API.

In some implementations, an API call reports to an application what the capabilities of a device running the application are, such as: input capability, output capability, processing capability, power capability, communications capability, etc.

A number of implementations have been described. Nevertheless, it will be understood that various modifications may be made. For example, other steps may be provided, or steps may be eliminated, from the described flows, and other components may be added to, or removed from, the described systems. Accordingly, other implementations are within the scope of the following claims.

Although a variety of examples and other information has been used to explain aspects within the scope of the appended claims, no limitation of the claims should be implied based on particular features or arrangements in such examples, as one of ordinary skill would be able to use these examples to derive a wide variety of implementations. Further, although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method of updating a storage device controller in a computing device, comprising:
receiving, by the storage device controller, a firmware image from a management controller for the computing device;
determining, by the storage device controller, that the firmware image should be applied to the storage device controller;
upon the determining that the updated firmware image should be applied to the storage device expander, storing, by the storage device controller, a new firmware based on the firmware image within memory associated with the storage device controller; and
rebooting the storage device controller using the new firmware.

2. The method of claim 1, further comprising:
storing the new firmware in a first region in the memory, the memory including the first region and a second region, wherein the second region includes a current firmware in use by the storage device controller; and
after storing the new firmware image in the first region, rebooting the storage device controller from the first region.

3. The method of claim 2, wherein the first region is an inactive region and the second region is an active region.

4. The method of claim 1, wherein the management controller is a baseboard management controller (BMC).

5. The method of claim 1, further comprising:
operating the storage device controller using a current firmware in an active region of the memory;
storing the new firmware in an inactive region of the memory;
after storing the new firmware image in the inactive region of the memory, causing the first region to become the active region; and
rebooting the storage device controller to cause the storage device controller to run from the active region.

6. The method of claim 5, wherein the active region and the inactive region are set using a set of active values.

7. The method of claim 1, wherein the storage device controller is a serial attached small computer interface (SAS) expander.

8. A non-transitory computer readable medium, having stored thereon a plurality of code section for causing a management controller of at storage node to perform a method comprising:
identifying a storage device controller in the storage node that is operating normally;
transmitting a firmware image to the storage device controller;
determining whether the firmware image was received by the storage device controller without errors;
generating a success log indicating that the firmware image was received by the storage device controller without errors; and
sending the success log to an administrator device.

9. The computer-readable medium of claim 8, further comprising code sections for causing the management controller to perform steps comprising:
determining that the firmware image was received by the storage device controller with errors;
generating a failure log indicating that the firmware image was received by the storage device controller with errors; and
sending the failure log to the administrator device.

10. A server system comprising:
a storage device controller;
a management controller communicatively coupled to the storage device controller and a communications network; and
at least one storage device communicatively coupled to the storage device controller;
wherein the management controller is configured to receive a firmware image over the network from an administrative device and send the updated firmware image to the storage device controller, and wherein the storage device controller is configured for receiving the firmware image from the management controller, writing a firmware based on the firmware image to one of the storage device controller or the at least one storage device, analyzing the firmware, and determining whether to set the one of the storage device controller or the at least one storage device to utilize the firmware based on the analyzing.

11. The server system of claim 10, wherein the management controller is a baseboard management controller (BMC).

12. The server system of claim 10, wherein the storage device controller is a serial attached small computer interface (SAS) expander.

13. The server system of claim 10, wherein the writing comprises storing the firmware in an inactive region of a memory device, and wherein the setting comprises:
setting the inactive region of the memory device to be the active region of the memory device;
rebooting the one of the storage device controller or the at least one storage device using the firmware in the active region.

14. The server system of claim 10, wherein the analyzing comprises determining that the firmware is valid, and wherein the determining comprises setting the one of the storage device controller or the memory device to use the firmware if the firmware is valid.

15. The server system of claim 10, wherein the storage device controller is further configured for detecting an error in the firmware image and forwarding a error message to the management controller.

16. A method comprising:
receiving, from a first controller device at a second controller device, a firmware image;
determining, by the second controller device, that the firmware image is for updating firmware of one or more storage devices associated with the second controller device; and
installing, by the second controller device, the updated firmware image on the one or more storage devices.

17. The method of claim 16, wherein the first controller is a baseboard management controller.

18. The method of claim 16, wherein the second controller is a serial attached small computer system interface (SAS) expander.

19. The method of claim 16, further comprising:
storing the firmware image in a first region of a memory device in at least one of the storage devices, the memory device including the first region and a second region, wherein the second region includes firmware executed by the at least one of the storage devices prior to receiving the updated firmware image; and
after storing the updated firmware image in the first region, rebooting the at least one of the storage devices from the first region.

20. The method of claim 19, wherein each of the first region and a second region comprise active values for indicating an active one and inactive one of the first and the second regions, and further comprising swapping the active values prior to the rebooting.
